(19) United States
(12) Patent Application Publication
(10) Pub. No.: US 2011/0143136 A1
(43) Pub. Date: Jun. 16, 2011

(54) FLUOROPOLYMER FILM WITH EPOXY ADHESIVE

(75) Inventors: Larry S. HEBERT, Hudson, WI (US); Naiyong Jing, Woodbury, MN (US)

(73) Assignee: 3M Innovative Properties Company

(21) Appl. No.: 12/967,438

(22) Filed: Dec. 14, 2010

Related U.S. Application Data
(60) Provisional application No. 61/286,420, filed on Dec. 15, 2009.

(51) Int. Cl. B32B 7/12

(52) U.S. Cl. 428/355 EP

(57) ABSTRACT

Protective articles are provided which include a fluoropolymer film and an epoxy adhesive, borne on at least one surface of the fluoropolymer film. The Protective articles include multilayer articles comprising a) a fluoroplastic layer, in contact with b) at least one curable adhesive layer, comprising a mixture of an uncured epoxide resin and curative agents selected from the group consisting of dicyandiamide, 4,4-aminophenyl disulfide, guanidine carbonate, thiourea and combinations thereof. Most typically, the curative agent includes dicyandiamide and in some embodiments consists essentially of dicyandiamide.

### CROSS REFERENCE TO RELATED APPLICATION

This application claims the benefit of U.S. Provisional Patent Application No. 61/286,420, filed Dec. 15, 2009, the disclosure of which is incorporated by reference herein in its entirety.

### FIELD OF THE DISCLOSURE This disclosure relates to protective articles which include a fluoropolymer film and an epoxy adhesive, borne on at least one surface of the fluoropolymer film.

### BACKGROUND OF THE DISCLOSURE

Painting has long been the process of choice for applying coatings to surfaces, especially those having complex curvature. The painting process is well understood and produces quality coatings having uniform properties even when the surface includes complex curvature. However, painting is falling under closer environmental scrutiny because it uses volatile solvents to carry the additives, or because of the additives themselves, or because of the surface chemicals used to clean and prepare the surface, or because of the chemicals used to remove the paint from the surface.

There has been much effort to replace painting with tapes and films, to be applied to a surface in lieu of paint. Many buildings use exterior treatments such as siding, roofing or trim that are applied as tape or are protected by a film affixed to the surface.

Some investigators report the use of conformable sheet materials, decals or appliqués to cover surfaces of complex curvature. The following references may be relevant to such a technology: U.S. Pat. No. 4,986,496 (Marentic et al.) and U.S. Pat. No. 5,660,667 (Davis).

### SUMMARY OF THE DISCLOSURE

Briefly, the present disclosure provides a multilayer article comprising a) a fluoroplastic layer, in contact with b) at least one curable adhesive layer, comprising a mixture of an uncured epoxide resin and curative agents selected from the group consisting of dicyandiamide, 4,4-aminophenyl disulfide, guanidine carbonate, thiourea and combinations thereof. Typically, the curative agent includes dicyandiamide. In some embodiments, the curative agent is consisting essentially of dicyandiamide. In some embodiments, the fluoroplastic comprises a non-perfluorinated fluoropolymer, typically a non-perfluorinated fluoropolymer is derived at least in part from vinylidene difluoride monomer. In some embodiments, the the fluoroplastic comprises a surface-treated perfluorinated fluoropolymer. In some embodiments, the epoxide resin is a phenolic compound. In some embodiments, the epoxide resin has a functionality greater than 2. In some embodiments, the cure site is selected from a nitrogen, a bromine, a chlorine, or an iodine containing cure site, an olefin, and combinations thereof. In some embodiments, the epoxide resin is selected from the group consisting of creosol Novolak, epichlorohydrin/tetraphenylol ethane, bisphenol A/epichlorohydrin, Novolak/bisphenol A, epichlorohydrin/phenol-formaldehyde, 9,9 bis-2,3 epoxypropylphenyl fluorine, epoxypropylphenyl fluorene, bisphenol AF/epichlorohydrin, Novolak/bisphenol AF, and combinations thereof

### DETAILED DESCRIPTION

The present disclosure relates to protective articles which include fluoropolymer films and adhesive on at least one surface of the fluoropolymer film. In some embodiments, the present disclosure provides a protective article which comprises at least one fluoropolymer layer and at least one curable layer where the curable layer is curable at elevated temperatures.

In another aspect, the fluoroploymer layer is a non-perfluorinated fluoropolymer.

In another aspect, the curable layer is an epoxy cured with curative agents including dicyandiamide.

In another aspect, the protective article is affixed to a least one layer of fiber reinforced resin matrix comprising a cured resin matrix.

In another aspect, the protective article is applied to a substrate of fiber reinforced resin matrix comprising a curable resin matrix and cured at elevated temperature.

The protective articles of the disclosure have many different uses including use to protect entire surfaces, portions of surfaces or edges of coatings, films, and substrates, and to repair coatings, films and substrates. Such protective articles are useful on vehicles, such as planes, trains, automobiles, boats, and ships. They can be used on painted, primed (for example, epoxy primer), or bare surfaces. They can be used on metal surfaces, on surfaces of composite materials, such as carbon fiber reinforced plastics, or within the construction of composite materials. The protective articles of the present disclosure can be in a variety of shapes, sizes, and thicknesses. They can be in the form of sheet materials or they can be formed to three-dimensional shaped articles, such as a formed boot, or they can be molded as three-dimensional fixtures.

Backings of the protective articles of the present disclosure include one or more fluorinated polymers, typically fluoroplastic rather than fluoroelastic polymers. Herein, a polymer includes homopolymers and copolymers. Copolymers include polymers containing two or more different monomers, including ter-polymers, tetrapolymers, etc. Preferably, the fluorinated polymers are prepared from olefinically unsaturated monomers. Also, preferably, the fluorinated polymers are not perfluorinated. That is, although they may be made from perfluorinated monomers, the resultant polymers have both C—H and C—F bonds, for example. Additionally, the fluorinated polymer used in the backing is not required to be functionalized. Preferably, fluorinated polymers suitable for use in making backings for protective articles of the present disclosure are those that form conformable, fluid-resistant sheet materials. As used herein, a “Conformable” backing is one that can be applied to various contoured and/or complex surfaces and maintains intimate contact with the entire surface for the time required for the desired application. Preferably, a conformable backing passes the conformability test described in PCT Publication WO 99/64235. A fluid-resistant backing is one that does not demonstrate a change in weight by more than about 10 percent after being immersed in a hydrocarbon fluid (for example, jet fuel) or a phosphate ester hydraulic fluid (for example, SKYDROL hydraulic fluid) for 14 days, or in strippers of paint (for example methylene chloride or benzyl alcohol for 2 days at room temperature.

One class of useful fluorinated polymers include interpolymerized units derived from vinylidene fluoride (also referred to as “VF2” or “VDF). Such materials typically include at least about 3 weight percent of interpolymerized units derived from VF2, which may be homopolymers or copolymers with other ethylenically unsaturated monomers, such as hexafluoropropylene (“HFP), tetrafluoroethylene (“TFE”), chlorotrifluoroethylene (°CTFE), 2-chloropentafluoropropene, perfluoroalkyl vinylethers, perfluorodiallylether, perfluoro-1,3-butadiene, and the like. Such fluorine-containing monomers may also be copolymerized with fluorine-free terminally unsaturated olefinic comonomers, such as ethylene or propylene. Preferred such fluoropolymers include tetrafluoroethylene-hexafluoropropylene-vinylidene fluoride terpolymers and hexafluoropropylene-vinylidene fluoride copolymers. Commercially available fluoropolymer materials of this type include, for example, THV 200, THV 400, and THV 500 fluoropolymers, which are available from Dyneon LLC of Oakdale, Minn., and SOLEF 11010, which is available from Solvay Polymers Inc., Houston, Tex.

Another class of useful fluorinated polymers include inter-polymerized units derived from one or more of hexafluoropropylene (“HFP”), tetrafluoroethylene (“TFE”), chlorotrifluoroethylene (°CTFE), and/or other perhalogenated monomers and further derived from one or more hydrogen-containing and/or non-fluorinated olefinically unsaturated monomers. Useful olefinically unsaturated monomers include alkylene monomers, such as ethylene, propylene, 1-hydropentafluoropropene, 2-hydropentafluoropropene, etc. A preferred such fluoropolymer is a copolymer of poly(tetrafluoroethylene) and ethylene. Commercially available fluoropolymer materials of this type include, for example, TEFZEL LZ300 fluoropolymers, which are available from DuPont Films, Buffalo, N.Y.

Other useful fluorinated polymers, preferably non-perfluorinated polymers, include poly(vinylfluoride), such as TEDLAR TAW15AHS, which is available from DuPont Films of Buffalo, N.Y. Blends of fluoropolymers can also be used to make the backings for the protective articles of the present disclosure. For example, blends of two different types of non-perfluorinated fluoropolymers can be used, as well as blends of a non-perfluorinated fluoropolymer with a perfluorinated fluoropolymer. Furthermore, blends of fluoropolymers with nonfluoropolymers, such as polyurethane and polyethylene, for example, can also be used, as long as one of the polymers in the blend is a fluoropolymer, and the nonfluoropolymer is used in a minor amount. Fluorinated polymer backings for use in the present disclosure can be made using a variety of methods, including cast and extrusion methods, preferably, however, they are extruded.

The backings may be clear and colorless, or include a colorant, such as a pigment or dye as the application desires. Preferably, the colorant is an inorganic pigment, such as those disclosed in U.S. Pat. No. 5,132,164. The pigment may be incorporated into one or more nonfluorinated polymers, which can be blended with one or more fluorinated polymers. The backings may be finish and/or color-matched to existing appliqué or paint color schemes. The backings are typically in the form of sheet materials having two major surfaces. The backings may also include additives to give the surface desired physical properties, such as gloss, color, reflectivity, or combinations thereof. The backings may also include additives or features that increase friction, reduce friction, or reduce accumulation of ice, dirt, grime or other contaminates.

Optionally, at least one of the surfaces may be treated to allow for bonding of the adhesive or overcoatings. Such treatment methods include corona treatment, particularly corona discharge in an atmosphere containing nitrogen, and about 0.1 to about 10 volume percent of an additive gas selected from the group consisting of hydrogen, ammonia, and mixtures thereof, as disclosed in U.S. Pat. No. 5,972,176 (Kirk et al.). Another useful treatment method includes a chemical etch using sodium naphthalenide. Such treatment methods are disclosed in Polymer Interface and Adhesion, Souheng Wu, Ed., Marcel Dekker, Inc., NY and Basel, pp. 279-336 (1982), and Encyclopedia of Polymer Science and Engineering, Second Edition, Supplemental Volume, John Wiley & Sons, pp. 674-689 (1989). Another useful treatment method is the FLUOROETCH process, available from Acton Industries, Inc., Pittston, Pa. Other useful treatments for surface modification of fluoropolymers include methods that expose a light absorbing electron donor to actinic radiation in the presence of a fluoropolymer such as those disclosed in U.S. Pat. No. 6,630,047 (Jing et al.) and U.S. Pat. No. 6,685,793 (Jing). Other treatment methods include the use of such materials as primers. These may be employed either in place of, or in addition to the surface treatments described above. An example of a useful primer is ADHESION PROMOTER #86A (a liquid primer, available from Minnesota Mining and Manufacturing Company, St. Paul, Minn.).

The curable layer of the present disclosure comprises a thermally or moisture curable adhesive on at least one surface of the backing. Examples of such curable adhesives include epoxy resins (epoxide resin+curing agent), acrylates, cyano-acrylates, and urethanes. The curable adhesives used in the process of the present disclosure are non-tacky to the touch after curing and are thermosetting, that is cure through the action of heat, catalysts, UV light, and the like. Epoxide resins useful in the protective articles of this disclosure are any organic compounds having at least one oxirane ring, that is, polymerizable by a ring opening reaction. Such materials, broadly called epoxides, include both monomeric and polymeric epoxides and can be aliphatic, heterocyclic, cycloaliphatic, or aromatic and can be combinations thereof. They can be liquid or solid or blends thereof, blends being useful in providing tacky adhesive films prior to cure. These materials generally have, on the average, at least two epoxy groups per molecule and are also called “polyepoxides.” The polymeric epoxides include linear polymers having terminal epoxy groups (for example, a diglyciclyl ether of a polyoxyalkylene glycol), polymers having skeletal oxirane units (for example, polybutadiene polyepoxide), and polymers having pendent epoxy groups (for example, a glycidyl methacrylate polymer or copolymer). The molecular weight of the epoxy resin may vary from about 74 to about 100,000 or more. Useful epoxide resins include those which contain cyclohexene oxide groups such as the epoxycyclohexane carboxylates, typified by 3,4-epoxycyclohexylmethyl-3,4-epoxycyclohexane carboxylate, 3,4-epoxy-2-n˜ethylcyclohexylmethyl-3,4-epoxy-2-methycyclohexane carboxylate, and bis(3,4-epoxy-6-methylcyclohexylmethyl) adipate. For a more detailed list of useful epoxides of this nature, reference may be made to U.S. Pat. No. 3,117,099. Further epoxide resins which are particularly useful in the practice of this disclosure include glycidyl ether monomers of the formula:

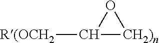

where R′ is aliphatic, for example, alkyl; aromatic, for example, aryl; or combinations thereof, and n is an integer of 1 to 6. Examples are the glycidyl ethers of polyhydric phenols such as the diglycidyl ether of 2,2-bis-(4-hydroxyphenol)propane (Bisphenol A) and copolymers of (chloromethyl)oxirane and 4,4′-(1-n1et1˜ylethylidene)bisphenol. Further examples of epoxides of this type which can be used in the practice of this disclosure are described in U.S. Pat. No. 3,018,262.

There are a host of commercially available epoxide resins that call be used in this disclosure. In particular, epoxides which are readily available include styrene oxide, vinylcyclohexene oxide, glycidol, glycidyl methacrylate, diglycidyl ether of Bisphenol A (for example, those available under the trade designations “EPON S28”, “EPON 1004”, 5 and “EPON 1001F from Shell Chemical Company, and “DER-332” and “DER-334”, from Dow Chemical Company), diglycidyl ether of Bisphenol F (for example, those under the trade designations “ARALDITE GY28 1” from Ciba-Geigy Corporation, and “EPON 862” from Shell Chemical Company), vinylcyclohexane dioxide (for example, having the trade designation “ERL-4206” from Union Carbide Corporation), 3,4-epoxycyclohexyl-methyl-3,4-epoxycyclohexene carboxylate (for example, having the trade designation “ERL-4221” from Union Carbide Corporation), 2-(3,4-epoxycyclohexyl-5,5-spiro-3,4-epoxy)cyclohexane-metadioxane (for example, having the trade designation “ERL-4234” from Union Carbide Corporation), bis(3,4-epoxycyclohexyl)adipate (for example, having the trade designation “ERL-4299” from Union Carbide Corporation), dipentene dioxide (for example, having the trade designation “ERL-4269” from Union Carbide Corporation), epoxidized polybutadiene (for example, having the trade designation “OXIRON 2001” from FMC Corporation), flame retardant epoxide resins (for example, having the trade designation “DER-542”, a brominated bisphenol type epoxy resin available from Dow Chemical Company), 1,4-butanediol diglycidyl ether (for example, having the trade designation “ARALDITE RD-2” from Ciba-Geigy Corporation), diglycidyl ether of hydrogenated Bisphenol A based epoxide resins (for example, having the trade designation “EPONEX 1510 from Shell Chemical Company), and polyglycidyl ether of phenol-formaldehyde novolak (for example, having the trade designations “DEN-43 1” and “DEN-438” from Dow Chemical Company)

The term “Curing agent” is used broadly to include not only those materials that are conventionally regarded as curing agents but also those materials that catalyze epoxy polymerization as well as those materials that may act as both curing agent and catalyst. Preferred curing agents for the epoxide resin include, for example, room temperature curing agents, heat-activated curing agents, and combinations thereof, and photolytically activated curing agents. Room temperature curing agents and heat-activated curing agents can include, for example, blends of epoxy homopolymerization type curing agents and addition type curing agents. The curing agents preferably react at temperatures of between about room temperature and about 200° C., more preferably about room temperature and 150° C., even more preferably between about room temperature and about 115° C. If the curing agents are used in epoxy resins that are used to make prepregs to make composite articles, then the curing agents preferably react at temperatures in the range of about 200° F. (93° C.) to about 450° F. (230° C.).

Preferred curative agents for composite articles cured in this temperature range include dicyandiamide as the curing agent or as one of the curing agents. Pre-cured epoxide resin combined with dicyandiamide is highly stable at room temperature; thusly they can be combined with the expectation of a very stable material providing long shelf life at ambient temperatures and a suitable cure at elevated temperatures. Dicyandiamide cured epoxy resins are known to be less yellow than epoxy resins cured with other methods and are known to resist oxidation better than epoxy resins cured with other methods. In some embodiments the curative agents exclude amine curatives.

Commercially available examples of curable adhesives include 3M™ Scotch-Weld™ Structural Adhesive Film AF 555, which includes dicyandiamide curative, 3M™ Scotch-Weld™ Structural Adhesive Film AF 191, which includes dicyandiamide curative, and 3M™ Scotch-Weld™ Structural Adhesive Film AF 163-2 (all available from 3M Company, St. Paul, Minn.).

The curable adhesive compositions used in the protective articles of the present disclosure can include conventional additives such as tackifiers, plasticizers, flow modifiers, neutralizing agents, stabilizers, antioxidants, fillers, colorants, and the like, as long as they do not interfere with the performance of the adhesive. The curable adhesive compositions may also contain anti-corrosion additives or materials. Such additives can be used in various combinations. If used, they are incorporated in amounts that do not materially adversely affect the desired properties of the cured adhesives. Typically, these additives can be incorporated into these systems in amounts of about 0.05 weight percent to about 25 weight percent, based on the total weight of the epoxide composition.

Optionally, the protective articles of the disclosure may have a topcoat. The topcoat can be placed on top of the fluoropolymer film of the protective article to increase protection and/or change the appearance of the protective article. For example, a topcoat of a fluoroelastomer may be applied to impart additional thermal and rain resistance to the protective article. An example of such a fluoroelastomer is a modified CAAPCOAT Type III or TYPE IV fluoroelastomer available from the CAAP Company suitable for roll coating in the appropriate colors and with appropriate additives. Another example of a top coat is a cured urethane topcoat. Cured urethane topcoats can be made from the reaction products of a hydroxy-containing material (base material) and isocyanate-containing material (activator) for example, polyisocyanate. Such curable compositions having the hydroxy- and isocyanate-containing materials may also further comprise a colorant. The curable compositions usually contain solvents and may also further contain other additives such as UV stabilizers, antioxidants, corrosion inhibitors, curing catalysts, and the like.

### Paint Primer Coating

Protective articles of the present disclosure can be prepared using standard film forming and adhesive-coating techniques. Typically, a fluoropolymer is extruded onto a carrier, such as polyethylene terephthalate film, which can be smooth or rough for glossy or matte finish backings, to form a backing The backing is then allowed to cool and solidify. The exposed surface of the backing is then optionally treated. A layer of curable adhesive is then applied to the surface of the backing The entire surface of the fluorinated polymer backing may be completely or partially covered with a curable adhesive. The thickness of the curable adhesive is not limited and an optimum thickness would likely depend upon the type and surface geometry or finish of the substrate to be bonded. Good substrate adhesion has been demonstrated using a very thin curable adhesive thickness, for example, about 0.0025 cm. However, thinner curable adhesive layers could be used if the desired level of adhesion is obtained on the selected substrate. A wide variety of coating techniques can be used, such as knife coating, roll coating, etc. The curable adhesive can also be applied using solvent cast techniques, for example. Alternatively, a layer of curable adhesive could be laminated to the backing If desired, a release liner can be applied over the adhesive layer. If desired, the carrier for the backing may be removed, the exposed surface of the backing may be treated as described above for enhanced adhesion to another adhesive, for example, a pressure sensitive adhesive, or for enhanced adhesion to a coating.

In the practice of this disclosure, a protective article of the disclosure may be used in the initial production of a protected substrate, for example, a composite article, or used in the field on substrates in which case the curable adhesive may be cured at the require elevated temperature. The required elevated temperature may be provided by known means such as IR lamps, heat guns, portable heaters, and the like. In general, the protective articles of the disclosure can be used on any substrate to which the curable adhesive will bond thereto. Examples of such substrates include painted surfaces, primed surfaces, metallic surfaces, ceramics, cured and un-cured composite surfaces, fluorinated polymer surfaces, plated surfaces, galvanized surfaces, other appliqués, and the like. The outer exposed surface of the protective article construction of the present disclosure may be provided with a patterned structure. Such patterned structures are useful for reducing fluid (for example, air, water) drag resistance over and/or across the exposed surface. Such patterned structures and means of providing them are taught in U.S. Pat. Nos. 5,133,516 and 5,548,769.

Embodiments of the present disclosure include the following enumerated items:
Item 1. A multilayer article comprising a) a fluoroplastic layer, in contact with b) at least one curable adhesive layer, comprising a mixture of an uncured epoxide resin and curative agents including dicyandiamide.
Item 2. A multilayer article comprising a) a fluoroplastic layer, in contact with b) at least one curable adhesive layer, comprising a mixture of an uncured epoxide resin and curative agents selected from the group consisting of dicyandiamide, 4,4-aminophenyl disulfide, guanidine carbonate, thiourea and combinations thereof.
Item 3. The article of item 1 or 2 wherein the fluoroplastic comprises a non-perfluorinated fluoropolymer.
Item 4. The article of item 3 wherein the non-perfluorinated fluoropolymer is derived at least in part from vinylidene difluoride monomer.
Item 5. The article of item 1 or 2 wherein the fluoroplastic comprises a surface-treated perfluorinated fluoropolymer.
Item 6. The article of item 1 or 2 wherein the fluoroplastic comprises a surface-treated fluoropolymer.
Item 7. The article of any of the preceding items wherein the fluoroplastic layer bears two curable adhesive layers.
Item 8. The article of any of the preceding items wherein the epoxide resin is a phenolic compound.
Item 9. The article of any of the preceding items wherein the epoxide resin has a functionality greater than 2.
Item 10. The article of any of the preceding items wherein the cure site is selected from a nitrogen, a bromine, a chlorine, or an iodine containing cure site, an olefin, and combinations thereof.
Item 11. The article of any of the preceding items wherein the fluoroplastic polymers include one or more than one cure site.
Item 12. The article of any of the preceding items wherein the nitrogen containing cure site is a nitrile containing cure site.
Item 13. The article of any of the preceding items wherein the epoxide resin is selected from the group consisting of creosol Novolak, epichlorohydrin/tetraphenylol ethane, bisphenol A/epichlorohydrin, Novolak/bisphenol A, epichlorohydrin/phenol-formaldehyde, 9,9 bis-2,3 epoxypropylphenyl fluorine, epoxypropylphenyl fluorene, bisphenol AF/epichlorohydrin, Novolak/bisphenol AF, and combinations thereof.

Objects and advantages of this disclosure are further illustrated by the following examples, but the particular materials and amounts thereof recited in these examples, as well as other conditions and details, should not be construed to unduly limit this disclosure.

### EXAMPLES

Unless otherwise noted, all reagents were obtained or are available from Aldrich Chemical Co., Milwaukee, Wis., or may be synthesized by known methods.

### Methods

### General Tooling and Bagging of a Composite Part

A composite specimen with a curable epoxy adhesive resin was prepared for curing in the following manor. A flat tool was fabricated by trimming to 2 ft×2 ft a 12 gauge stainless steel alloy 304 with 2B finish. A 1 mil PTFE non-perforated parting film (available as HTF-621 from Northern Fiber Glass Sales, Inc.) was applied to the tool and affixed thereon with heat resistant tape applied at the edges and corners of the film. Each layer of material was applied to the tool in the order and arrangement described in the example text. Each layer was applied first to the tool, then one upon the other without liners by hand and each layer was consolidated with the previous layer(s) by passing a 1.5 inch diameter wooden roller over the upper-most layer while applying hand pressure to the roller. After every forth ply, the part and tool were covered with a layer of perforated parting film described below and then a layer of breather ply described below and the part was compacted to the tool under full vacuum in a Scotchlite Vacuum Applicator Model VAL-1 manufactured by 3M for 3 minutes after which time the breather ply and perforated parting film were removed and additional plies were added to the part. Each coupon was permanent marked by applying a unique identifier along one edge of the part on the exposed face of the part using a Pilot Silver Marker. A perforated parting film available as A5000 from Richmond Aircraft Products was applied wrinkle-free so as to completely cover the exposed face of the coupon. 1 thermocouple was attached to the tool within 2 inches of the coupon. A layer of non-perforated parting film was applied to the bed of the autoclave described below to cover the area where the tools were placed. The tool and part were placed on the bed of the autoclave described below and a continuous bead of vacuum bag sealing tape was applied directly to the bed of the autoclave so that the distance from the tape to the tool was at least 3 inches. The exposed non-perforated parting film on the bed of the autoclave was folded or trimmed clear of the vacuum bag sealing tape. A non-woven polyester 10 oz/yd² felt breather ply (available as RC-3000-10 from Richmond Aircraft Products) was overlaid upon the part and the tool and onto the bed of the autoclave such that it extended to within 2 inches of the vacuum bag sealing tape on all sides. A 3 mil high temperature nylon bagging film (available as HS8171 from Richmond Aircraft Products) was placed loosely over the bed of the autoclave to cover the part and tools and to extend to or beyond the vacuum bag sealing tape on all sides. At least 1 vacuum port assembly was installed in the vacuum bag over the breather ply and the vacuum bag was sealed to the bed of the autoclave along all edges by pressing the film against the vacuum bag seal tape.

### High Pressure Curing of a Composite Part

A composite specimen with a curable epoxy adhesive resin was cured in the following manor. Each composite specimen with a curable epoxy adhesive resin was prepared for curing according to “General Tooling and Bagging of a Composite Part”. The vacuum port assembly(ies) was attached to the vacuum system in the autoclave described below and the parts, tools, parting films and breather plies were consolidated under full vacuum for 5 minutes. The thermocouples were attached to the control system in the autoclave. The part was then cured under controlled temperature and pressure conditions in one of two autoclaves, one made by Thermal Equipment Corporation or the other made by ASC Process Systems, using pressure and temperature profiles described below. The pressure inside the autoclave was increased to 60 psi and the temperature was increased at 5° F./minute until the temperature of the lagging thermocouple reached 177° C. The pressure was maintained between 60 psi and 70 psi and the temperature was maintained between 177° C. and 182° C. for 120 minutes. The temperature was reduced at a controlled rate of 5° F./minute until the temperature of the lagging thermocouple reached 44° C. The pressure was maintained between 60 psi and 70 psi until the temperature of the lagging thermocouple reached 66° C., then the pressure in the autoclave and the vacuum under the vacuum bag was vented to the atmosphere. The cured composite specimen was removed from the autoclave, bagging and tool.

### FEP Priming

A cleaned glass plate was primed with a 5 wt % solution of 3-aminopropyl triethoxysilane and N,N-dimethyl aniline in a ratio of 8:2 in methanol. Fluorinated ethylene propylene (FEP) film was laminated onto the primed glass. The film was in a good contact with the primer and the interface was free of air bubbles. Subsequently the laminated FEP was subjected to UV irradiation under a 254 nm Germcidal lamp for a certain period time. The treated side was then rinsed with water to remove any primer residue. The treated FEP side showed hydrophilic.

### General Laminating

Layers in the construction were brought together in combinations, order and quantities as described below. Removable carriers were separated from mating surfaces during the laminating process. These layers were laminated by feeding them at a rate of 2.5 ft/min into the nip of a Geppert Engineering Inc. laminator using 4 inch rubber rollers a ambient conditions (22° C.; 50 percent Relative Humidity).

### Intermediate Assembly Examples:

### Non-Perfluorinated Fluoropolymer Film (515)

Fluoropolymer films were provided or cast and used to make examples. These films included:
1 mil thick Dyneon™ Fluoroplastic PVDF 11010/0000 polyvinylidene fluoride
3 mil thick Dyneon™ Fluorothermoplastic THV500 from Dyneon™

### Laminated Assembly of AF555 Adhesive Film and a Fluoropolymer Layer (25)

A structural adhesive film (401) and a non-perfluorinated fluoropolymer film (515) were provided and used to prepare a bondable fluoropolymer film (25). More specifically, each non-perfluorinated fluoropolymer film (515) was joined and laminated to one side of an 8 mil thick epoxy film containing a non-woven polyester veil at 0.05 lbs./sqft as 3M™ Scotch-Weld™ Structural Adhesive Film AF 555M available from 3M (401) as described in “General Laminating” above. All remaining liners and carriers were removed, providing a bondable fluoropolymer film (25).

### Laminated Assembly of AF555 Adhesive Film and a Treated FEP Fluoropolymer Layer (25.1)

A structural adhesive film (401) and a pretreated non-perfluorinated fluoropolymer film (213) were provided and used to prepare a bondable FEP fluoropolymer film (25.1). More specifically, one side of 2 mil thick Dupont™ FEP was primed as described in “FEP Priming” above. One sample was then exposed to UV radiation for 10 minutes and the other sample was exposed to UV radiation for 20 minutes to create a pretreated non-perfluorinated fluoropolymer film (213). An 8 mil thick epoxy film containing a non-woven polyester veil at 0.05 lbs./sqft as 3M™ Scotch-Weld™ Structural Adhesive Film AF 555M available from 3M (401) was joined and laminated to the treated surface of the fluoropolymer film as described in “General Laminating” above. All remaining liners and carriers were removed, providing a bondable fluoropolymer film (25.1).

### Laminated Assembly of AF555 Adhesive Film and a FEP Fluoropolymer Layer (25.2)

A structural adhesive film (401) and a non-perfluorinated FEP fluoropolymer film (213) were provided and used to prepare a FEP fluoropolymer film (25.2). More specifically, one side of 2 mil thick Dupont™ FEP (213) was laminated as described in “General Laminating” above to one surface of an 8 mil thick epoxy film containing a non-woven polyester veil at 0.05 lbs./sqft as 3M™ Scotch-Weld™ Structural Adhesive Film AF 555M available from 3M (401). All remaining liners and carriers were removed, providing a fluoropolymer film (25.2).

### Laminated Assembly of AF191 Adhesive Film and a Fluoropolymer Layer (26)

A structural adhesive film (404) and a non-perfluorinated fluoropolymer film (515) were provided and used to prepare a bondable fluoropolymer film (26). More specifically, each non-perfluorinated fluoropolymer film (515) was joined and laminated to one side of a curable epoxy film containing a non-woven polyester veil as 3M™ Scotch-Weld™ Structural Adhesive Film AF191M available from 3M (404) as described in “General Laminating” above. All remaining liners and carriers were removed, providing a bondable fluoropolymer film (26).

### Laminated Assembly of AF191 Adhesive Film and a Treated Fluoropolymer Layer (26.1)

A structural adhesive film (404) and a pretreated non-perfluorinated fluoropolymer film (213) were provided and used to prepare a bondable fluoropolymer film (26.1). More specifically, one side of 2 mil thick Dupont™ FEP was primed as described in “FEP Priming” above. One sample was then exposed to UV radiation for 10 minutes and the other sample was exposed to UV radiation for 20 minutes to create a pretreated non-perfluorinated fluoropolymer film (213). A curable epoxy film containing a non-woven polyester veil as 3M™ Scotch-Weld™ Structural Adhesive Film AF191M available from 3M (404) was joined and laminated to the treated surface of the fluoropolymer film as described in “General Laminating” above. All remaining liners and carriers were removed, providing a bondable fluoropolymer film (26.1).

### Laminated Assembly of AF191 Adhesive Film and a FEP Fluoropolymer Layer (26.2)

A structural adhesive film (404) and a non-perfluorinated FEP fluoropolymer film (213) were provided and used to prepare a FEP fluoropolymer film (26.2). More specifically, one side of 2 mil thick Dupont™ FEP (213) was laminated as described in “General Laminating” above to one surface of a curable epoxy film containing a non-woven polyester veil as 3M™ Scotch-Weld™ Structural Adhesive Film AF191M available from 3M (404). All remaining liners and carriers were removed, providing a bondable fluoropolymer film (26.2).

### Cured Examples:

Cured Laminate with a Fluoropolymer Layer Bonded with a Di-Amine Cured Epoxy (Ex. 65)

Epoxy resin impregnated carbon fiber fabric and a bondable fluoropolymer film were provided and used to prepare a composite specimen. More specifically, the following materials were assembled and prepared as described in “General Tooling and Bagging of a Composite Part” above. Applied to the tool was a bondable fluoropolymer film (25), applied with the fluoropolymer layer closest to the tool and the adhesive layer exposed. Then applied were 8 plies epoxy resin impregnated woven plain weave graphite fabric 3K-70-PW available as Cycom 970/PWC FT300 3K UT from Cytec (100). Each fluoropolymer film was used to create a separate specimen. The curable resins in this assembly were cured as described in “High Pressure Curing of a Composite Part” above.

Cured Laminate with a Treated FEP Layer Bonded with a Di-Amine Cured Epoxy (Ex. 65.1)

Epoxy resin impregnated carbon fiber fabric and a bondable FEP fluoropolymer film were provided and used to prepare a composite specimen. More specifically, the following materials were assembled and prepared as described in “General Tooling and Bagging of a Composite Part” above. Applied to the tool was a bondable fluoropolymer film (25.1), applied with the fluoropolymer layer closest to the tool and the adhesive layer exposed. Then applied were 8 plies epoxy resin impregnated woven plain weave graphite fabric 3K-70-PW available as Cycom 970/PWC FT300 3K UT from Cytec (100). The curable resins in this assembly were cured as described in “High Pressure Curing of a Composite Part” above.

Cured Laminate with a FEP Layer Bonded with a Di-Amine Cured Epoxy (Ex. 65.2)

Epoxy resin impregnated carbon fiber fabric and a FEP fluoropolymer film were provided and used to prepare a composite specimen. More specifically, the following materials were assembled and prepared as described in “General Tooling and Bagging of a Composite Part” above. Applied to the tool was a FEP fluoropolymer film (25.2), applied with the fluoropolymer layer closest to the tool and the adhesive layer exposed. Then applied were 8 plies epoxy resin impregnated woven plain weave graphite fabric 3K-70-PW available as Cycom 970/PWC FT300 3K UT from Cytec (100). The curable resins in this assembly were cured as described in “High Pressure Curing of a Composite Part” above.

Cured Laminate with a Fluoropolymer Layer Bonded with a Dicyandiamide Cured Epoxy (Ex. 66)

Epoxy resin impregnated carbon fiber fabric and a bondable fluoropolymer film were provided and used to prepare a composite specimen. More specifically, the following materials were assembled and prepared as described in “General Tooling and Bagging of a Composite Part” above. Applied to the tool was a bondable fluoropolymer film (26), applied with the fluoropolymer layer closest to the tool and the adhesive layer exposed. Then applied were 8 plies epoxy resin impregnated woven plain weave graphite fabric 3K-70-PW available as Cycom 970/PWC FT300 3K UT from Cytec (100). Each fluoropolymer film was used to create a separate specimen. The curable resins in this assembly were cured as described in “High Pressure Curing of a Composite Part” above.

Cured Laminate with a Treated Fluoropolymer Layer Bonded with a Dicyandiamide Cured Epoxy (Ex. 66.1)

Epoxy resin impregnated carbon fiber fabric and a bondable FEP fluoropolymer film were provided and used to prepare a composite specimen. More specifically, the following materials were assembled and prepared as described in “General Tooling and Bagging of a Composite Part” above. Applied to the tool was a bondable fluoropolymer film (26.1), applied with the fluoropolymer layer closest to the tool and the adhesive layer exposed. Then applied were 8 plies epoxy resin impregnated woven plain weave graphite fabric 3K-70-PW available as Cycom 970/PWC FT300 3K UT from Cytec (100). The curable resins in this assembly were cured as described in “High Pressure Curing of a Composite Part” above.

Cured Laminate with a FEP Layer Bonded with a Dicyandiamide Cured Epoxy (Ex. 66.2)

Epoxy resin impregnated carbon fiber fabric and a FEP fluoropolymer film were provided and used to prepare a composite specimen. More specifically, the following materials were assembled and prepared as described in “General Tooling and Bagging of a Composite Part” above. Applied to the tool was a FEP fluoropolymer film (26.2), applied with the fluoropolymer layer closest to the tool and the adhesive layer exposed. Then applied were 8 plies epoxy resin impregnated woven plain weave graphite fabric 3K-70-PW available as Cycom 970/PWC FT300 3K UT from Cytec (100). The curable resins in this assembly were cured as described in “High Pressure Curing of a Composite Part” above.

### Evaluations

After curing, coupons from Examples 65, 65.1, 65.2, 66, 66.1, and 66.2 were trimmed with a diamond saw. Each specimen was tested for adhesion of the fluoropolymer layer to the substrate using a tape peel test. More specifically, cross-hatches were cut into each sample using a razor blade. Samples were tested for adhesion (initial) using 3M™ Aluminum Foil Tape 427 (this has a very aggressive adhesive and bonds well to the films). The tape was rolled down by applying pressure with 10 passes of a rubber roller, and the tape was rapidly peeled off. The adhesion test results are classified according to ASTM D3359. Samples were conditioned by soaking in water at 50° C. for 2 hrs. The conditioned samples were tested for adhesion using the same method. The results are summarized in Table 1.

Excellent adhesion was obtained by curing the fluoropolymer films at elevated temperatures to adhesives comprising a mixture of an uncured epoxide resin and curative agents including dicyandiamide. Adhesion on FEP examples improved from virtually no usable adhesion on Examples 65.2 and 66.2, to excellent adhesion on Examples 65.1 and 66.1, with the addition of a surface treatment.

TABLE 1

| | Initial | Adhesion after soaking in | |
|---|---|---|---|
| Example | Adhesion | water at 50° C. for 2 hours | Comments |
| 65 | 5B | 5B | |
| 65.1 | 5B | 5B | Same as 65.2 except |
| | | | used treated FEP |
| 65.2 | 0B | <1> | |
| 66 | 5B | 5B | |
| 66.1 | 5B | 5B | Same as 66.2 except |
| | | | used treated FEP |
| 66.2 | 0B | <1> | |

<1> FEP separated from substrate during conditioning.

Various modifications and alterations of this disclosure will become apparent to those skilled in the art without departing from the scope and principles of this disclosure, and it should be understood that this disclosure is not to be unduly limited to the illustrative embodiments set forth hereinabove.

We claim:

1. A multilayer article comprising a) a fluoroplastic layer, in contact with b) at least one curable adhesive layer, comprising a mixture of an uncured epoxide resin and curative agents selected from the group consisting of dicyandiamide, 4,4-aminophenyl disulfide, guanidine carbonate, thiourea and combinations thereof.

2. The multilayer article according to claim 1 wherein the curative agent includes dicyandiamide.

3. The multilayer article according to claim 1 wherein the curative agent is consisting essentially of dicyandiamide.

4. The article of claim 1 wherein the fluoroplastic comprises a non-perfluorinated fluoropolymer.

5. The article of claim 4 wherein the non-perfluorinated fluoropolymer is derived at least in part from vinylidene difluoride monomer.

6. The article of claim 1 wherein the fluoroplastic comprises a surface-treated perfluorinated fluoropolymer.

7. The article of claim 3 wherein the fluoroplastic comprises a non-perfluorinated fluoropolymer.

8. The article of claim 7 wherein the non-perfluorinated fluoropolymer is derived at least in part from vinylidene difluoride monomer.

9. The article of claim 3 wherein the fluoroplastic comprises a surface-treated perfluorinated fluoropolymer.

10. The article of claim 1 wherein the epoxide resin is a phenolic compound.

11. The article of claim 1 wherein the epoxide resin has a functionality greater than 2.

12. The article of claim 1 wherein the cure site is selected from a nitrogen, a bromine, a chlorine, or an iodine containing cure site, an olefin, and combinations thereof.

13. The article of claim 1 wherein the epoxide resin is selected from the group consisting of creosol Novolak, epichlorohydrin/tetraphenylol ethane, bisphenol A/epichlorohydrin, Novolak/bisphenol A, epichlorohydrin/phenol-formaldehyde, 9,9 bis-2,3 epoxypropylphenyl fluorine, epoxypropylphenyl fluorene, bisphenol AF/epichlorohydrin, Novolak/bisphenol AF, and combinations thereof.

14. The article of claim 3 wherein the epoxide resin is a phenolic compound.

15. The article of claim 3 wherein the epoxide resin has a functionality greater than 2.

16. The article of claim 3 wherein the cure site is selected from a nitrogen, a bromine, a chlorine, or an iodine containing cure site, an olefin, and combinations thereof.

17. The article of claim 3 wherein the epoxide resin is selected from the group consisting of creosol Novolak, epichlorohydrin/tetraphenylol ethane, bisphenol A/epichlorohydrin, Novolak/bisphenol A, epichlorohydrin/phenol-formaldehyde, 9,9 bis-2,3 epoxypropylphenyl fluorine, epoxypropylphenyl fluorene, bisphenol AF/epichlorohydrin, Novolak/bisphenol AF, and combinations thereof.

18. The article of claim 7 wherein the epoxide resin is a phenolic compound.

19. The article of claim 7 wherein the epoxide resin has a functionality greater than 2.

20. The article of claim 7 wherein the cure site is selected from a nitrogen, a bromine, a chlorine, or an iodine containing cure site, an olefin, and combinations thereof.

21. The article of claim 7 wherein the epoxide resin is selected from the group consisting of creosol Novolak, epichlorohydrin/tetraphenylol ethane, bisphenol A/epichlorohydrin, Novolak/bisphenol A, epichlorohydrin/phenol-formaldehyde, 9,9 bis-2,3 epoxypropylphenyl fluorine, epoxypropylphenyl fluorene, bisphenol AF/epichlorohydrin, Novolak/bisphenol AF, and combinations thereof.
